(19) United States
(12) Patent Application Publication
(10) Pub. No.: US 2013/0093774 A1
(43) Pub. Date: Apr. 18, 2013

(54) CLOUD-BASED ANIMATION TOOL

(71) Applicant: Bharath Sridhar, Bangalore (IN)

(72) Inventor: Bharath Sridhar, Bangalore (IN)

(21) Appl. No.: 13/272,293

(22) Filed: Oct. 13, 2011

(51) Int. Cl. G06T 13/00

(52) U.S. Cl. 345/473

(57) ABSTRACT

A cloud-based animation tool may improve the graphics capabilities of low-cost devices. A web service may allow a user to submit a text string from the device for animation by the cloud-based tool. The string may be parsed by a natural language processor into components such as nouns and verbs. The parsed words may be cross-referenced to content through a reference database, including instructions for verbs and images for nouns. An animation may be created from the images corresponding to the nouns and instructions corresponding to the verbs. The animation may be rendered for display and may be transmitted to the user through the web service. The cloud-based animation tool may improve access to educational material for students accessing content through low-cost devices made available through the one-computer-per-child program.

### TECHNICAL FIELD

The instant disclosure relates to cloud computing. More specifically, the instant disclosure relates to animating videos with a cloud-based computing system.

### BACKGROUND

Computer graphics, such as animations, require advanced computer processing capabilities. In particular, the rendering of animation sequences in two dimensions or three dimensions is real-time can be a challenging task for many computer processing systems. Recently, a trend is emerging towards mobile computing devices. Mobile devices are conventionally battery-powered and, thus, have limited resources. To improve the operating time of a mobile device and reduce the device's power requirements, mobile devices often have less powerful processing systems than fixed-location devices such as desktops and servers. Thus, the requirements for performing real-time graphics animation is juxtaposed with the requirements for highly mobile devices with long battery operating times.

### SUMMARY

According to one embodiment, a method includes receiving an input string. The method also includes parsing the input string to extract at least one noun and at least one verb. The method further includes retrieving at least one image from a database for each noun. The method also includes associating each of the verbs with at least one of the nouns. The method further includes creating a timeline animating the images corresponding to the nouns according to the verbs associated with the nouns.

According to another embodiment, a computer program product includes a non-transitory computer readable medium having code to receive an input string. The medium also includes code to parse the input string to extract at least one noun and at least one verb. The medium further includes code to retrieve at least one image from a database for each noun. The medium also includes code to associate each of the verbs with at least one of the nouns. The medium further includes code to create a timeline animating the images corresponding to the nouns according to the verbs associated with the nouns.

According to yet another embodiment, a system includes a natural language processor coupled to a web service to receive an input string and output nouns and verbs. The system also includes a reference database coupled to the natural language processor to receive nouns and verbs and output images corresponding to the nouns and instructions corresponding to the verbs. The system further includes a processor coupled to the reference database. The processor is configured to associate verbs with nouns. The processor is also configured to create a timeline animating an image associated with each noun according to instructions corresponding to the associated verb.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram illustrating a cloud-based visualization tool according to one embodiment of the disclosure.

FIG. 2 is a flow chart illustrating a method of visualizing text with a cloud-based service according to one embodiment.

FIG. 3 is a block diagram illustrating a web-based interface for accessing a cloud-based visualization tool according to one embodiment of the disclosure.

FIG. 4 is block diagram illustrating a data management system configured to store databases, tables, and/or records according to one embodiment of the disclosure.

FIG. 5 is a block diagram illustrating a data storage system according to one embodiment of the disclosure.

FIG. 6 is a block diagram illustrating a computer system according to one embodiment of the disclosure.

### DETAILED DESCRIPTION

Computing devices may benefit from off-loading animation processing to a cloud-based computing system. In particular, educational devices that are intended to reach students may have reduced processing capability compared to normal desktop computers. For example, educational devices issued through the one-computer-per-child program are low-cost and low-power devices. Because video processing is a very processor-intensive task for computing devices, low-cost educational devices may not have sophisticated graphics capability. Additionally, low-cost educational devices may not have large amounts of storage for reference databases. Creating animations for the educational device in a cloud-based computing system and delivering the animations to the educational device may improve the user's experience when interacting with the educational device. Although low-cost educational devices are provided as an example, a cloud-based animation tool may also improve the experience of other computing devices having reduced processing capability in comparison to desktop or server computing systems such as tablet computers, personal digital assistants (PDAs), smartphones, superphones, and cellular phones. Additionally, the cloud-based animation tool may deliver animations to desktop and server computers.

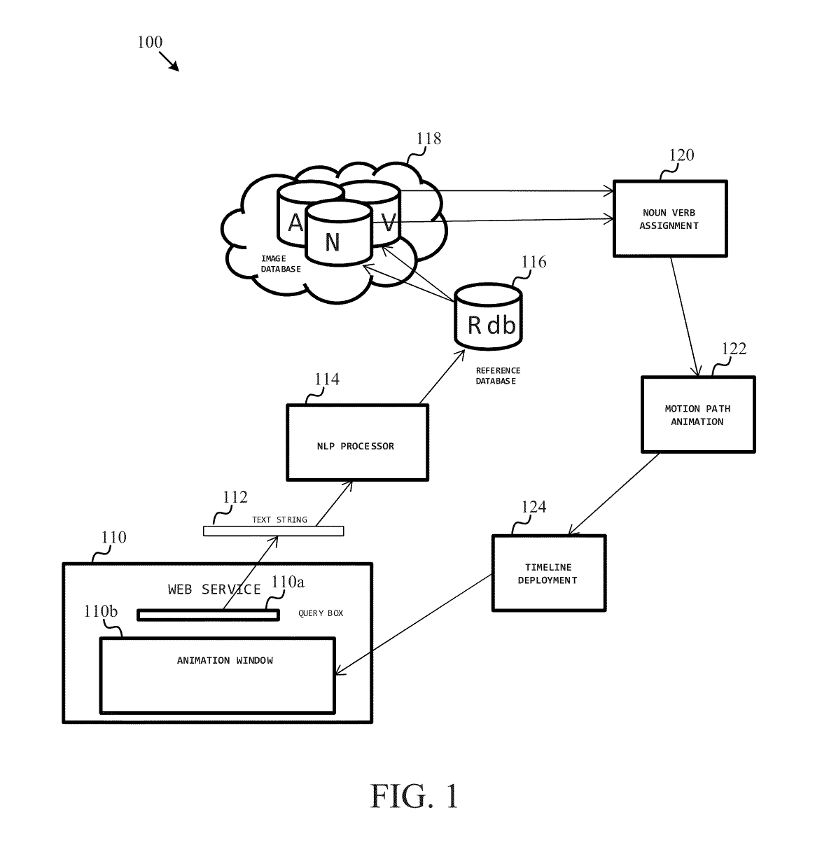

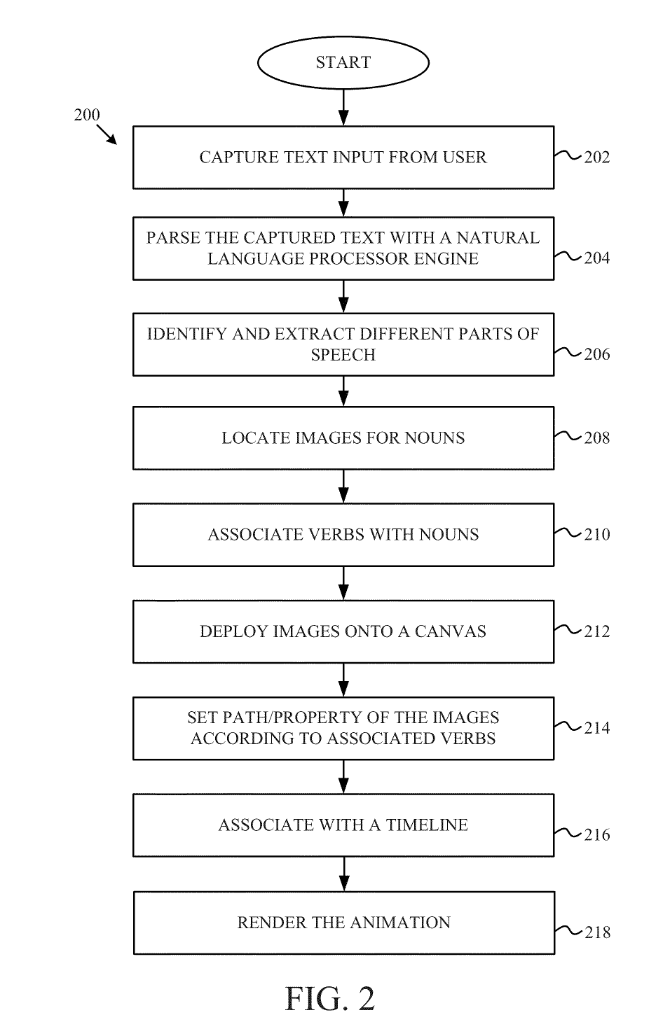

FIG. 1 is a block diagram illustrating a system 100 for a cloud-based visualization tool according to one embodiment of the disclosure. A web service may present a user interface 110 to a user through a client device. The client device may access the web service through a network connection, such as the Internet. The system 100 is described further below with reference to FIG. 2. FIG. 2 is a flow chart illustrating a method of visualizing text with a cloud-based service according to one embodiment. A method 200 begins at block 202.

At block 202 text input is captured from a user. A text string 112 may be entered by a user of the client device through a text box 110a of the user interface 110. The text string 112 is received by a natural language processor (NLP) 114.

At block 204 the natural language processor parses the text string 112 captured at block 202. The NLP 114 may identify and extract different parts of speech from the text string 112 at block 206. For example, the NLP 114 may extract nouns, verbs, adjectives, and/or adverbs. The extracted words are provided to a reference database 116.

At block 208 the reference database 116 locates images for the nouns. According to one embodiment, the reference database 116 includes a look-up table for known nouns. The look-up table may reference entries in external databases 118. For example, the reference database 116 may include an entry in the look-up table identifying the noun “house” with a particular image of a house in the database 118. Similarly, the reference database 116 may include look-up tables for identifying adjectives, verbs, and/or adverbs in the database 118. Verbs in the look-up table may reference animation instructions or motion paths in the database 118 for manipulating images corresponding to nouns. Adjectives and/or adverbs in the look-up table may reference instructions in the database 118 for manipulating images corresponding to nouns. For example, the look-up table may identify the adjective “red” with instructions in the database 118 for applying a red filter to an image.

At block 210 verbs from the parsed text are associated with nouns from the parsed text. For example, “the boy” may be associated with “walks.” That is, each verb is associated with an object for performing the action described by the verb. A noun-verb assignment processor 120 may associate the verbs with the nouns.

At block 212 the images corresponding to the nouns, located at block 208, may be inserted onto a virtual canvas. The canvas may include the noun images along with background art, which may be specified by a user through the user interface 110 of the web service, or the background art may be pre-configured for the system 100, or the background art may be determined by the NLP 114 based on context information in the received text string 112.

At block 214 a motion path or other property or action may be assigned to the nouns, extracted at block 206, in accordance with verbs associated with the nouns at block 210. For example, when a motion path processor 122 receives “walks” associated with “the boy,” the processor 122 may create a motion showing moving legs on an image of a boy received from the database 118 or manipulate the image of the boy according to instructions stored in the external database 118. In another example, “to his house” may result in the motion of the image of the boy moving towards a house displayed on the virtual canvas.

At block 216 the images on the virtual canvas, along with their assigned motion paths, are associated with a timeline by a timeline deployment processor 124. The processors 120, 122, and 124 may be one or multiple processors. The timeline processor 124 may arrange the motion of the nouns in the virtual canvas to create the final animation. For example, when multiple animations occur on the virtual canvas, the timeline processor 124 may arrange for one animation to complete before another animation begins, or the timeline processor 124 may arrange for the animations to occur simultaneously.

At block 218 the virtual canvas is rendered according to the timeline associated with the canvas at block 216 to generate an animation. The animation may be stored, for example, as a hypertext mark-up language 5 (HTML5) document, an animated vector graphics file, such as a Flash video file, and/or a video file, such as a MPEG-1, MPEG-2, or MPEG-4 video file. After the animation is rendered at block 218, the rendered file may be transmitted back to the client device for display on the user interface 110 in an animation window 110b.

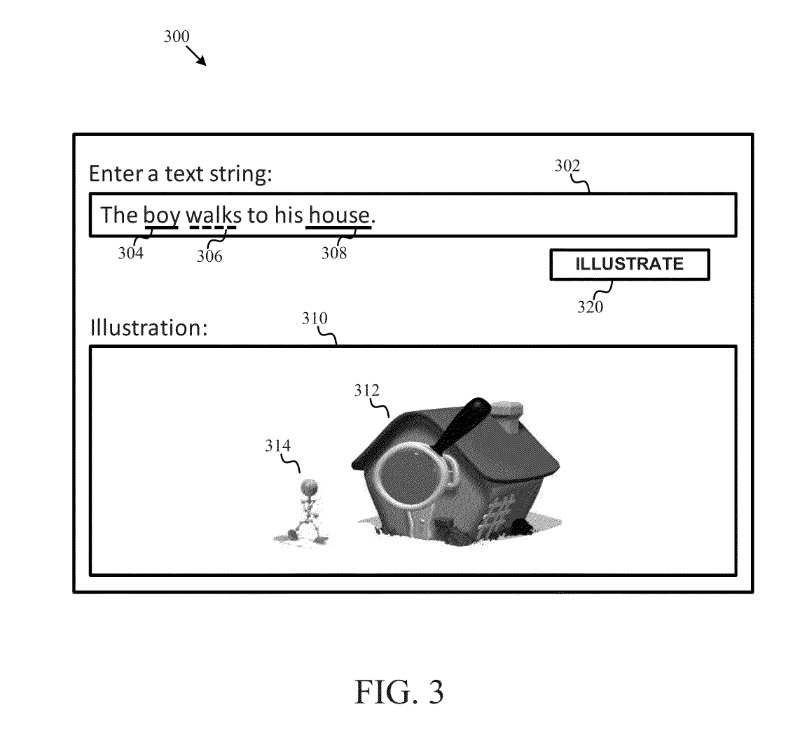

FIG. 3 is a block diagram illustrating a web-based interface for accessing a cloud-based visualization tool according to one embodiment of the disclosure. A user interface 300 includes a text box 302 for receiving a text string. When the user enters a text string in the text box 302 and activates the illustrate button 320, the text string is submitted by the device executing the user interface 300 to a server through, for example, a web service. The server may return an animation, which is displayed in an animation window 310. The user interface 300 may also include indicators 304, 306, and 308 indicating the nouns and verbs detected by the natural language processor in the text box 302. For example, a solid line 304 and 308 may be used to indicate nouns, and a dashed line 306 may be used to indicate verbs.

After a user clicks the illustrate button 320, the text string in the text box 302 may be submitted through the web server and an animation may be received and displayed in the animation window 310. The received file may be an HTML5 file, an animated vector graphics file, or a video file. According to one embodiment, the animation window 310 may be a floating frame in the user interface 300 for displaying an HTML5 file. According to another embodiment, the animation window 310 may include a plug-in for displaying an animated vector graphics file. According to yet another embodiment, the animation window 310 may include a embedded viewer for playing a video file. When the text string is “The boy walks to his house,” the animation windows 310 may include a by 314 and a house 312. An animation timeline may include the boy 314 walking towards the house 312, which is displayed in the animation window 310.

The cloud-based animation tool described above may improve the quality of education provided to children through low-cost low-power computing devices. In particular, these devices may be provided to low-income children and low-income countries. The animations may improve a student's understanding of the English language. However, the cloud-based animation tool may not be limited to only sentences.

A text string may be entered and answered by an animation produced from the cloud-based animation tool. For example, a text string containing a question may be submitted through the web service, such as “Where are planets in the universe?” When such a string is entered the natural language processor may parse the text for nouns and verbs and determine the information a student is requesting. An animation may be produced from the answer to the question entered into the text box. For example, an animation window may present an animation of the sun and planets orbiting around the sun after the students submits the question “Where are planets in the universe?”

The cloud-based animation tool is not limited to educational applications. The animation tool may be offered through a web page accessing the web service to provide custom animations to users. For example, a user may access the cloud-based animation tool to create an animation for a presentation.

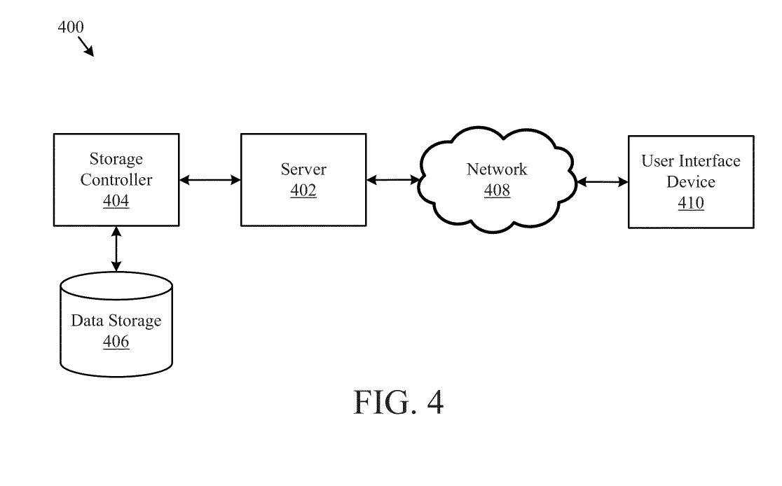

FIG. 4 illustrates one embodiment of a system 400 for an information system. The system 400 may include a server 402, a data storage device 406, a network 408, and a user interface device 410. The server 402 may be a dedicated server or one server in a cloud computing system. In a further embodiment, the system 400 may include a storage controller 404, or storage server configured to manage data communications between the data storage device 406, and the server 402 or other components in communication with the network 408. In an alternative embodiment, the storage controller 404 may be coupled to the network 408.

In one embodiment, the user interface device 410 is referred to broadly and is intended to encompass a suitable processor-based device such as a desktop computer, a laptop computer, a personal digital assistant (PDA) or table computer, a smartphone or other a mobile communication device or organizer device having access to the network 408. In a further embodiment, the user interface device 410 may access the Internet or other wide area or local area network to access a web application or web service hosted by the server 402 and provide a user interface for enabling a user to enter or receive information.

The network 408 may facilitate communications of data between the server 402 and the user interface device 410. The network 408 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate, one with another.

In one embodiment, the user interface device 410 accesses the server 402 through an intermediate sever (not shown). For example, in a cloud application the user interface device 410 may access an application server. The application server fulfills requests from the user interface device 410 by accessing a database management system (DBMS). In this embodiment, the user interface device 410 may be a computer executing a Java application making requests to a JBOSS server executing on a Linux server, which fulfills the requests by accessing a relational database management system (RDMS) on a mainframe server.

In one embodiment, the server 402 is configured to store databases, pages, tables, and/or records. Additionally, scripts on the server 402 may access data stored in the data storage device 406 via a Storage Area Network (SAN) connection, a LAN, a data bus, or the like. The data storage device 406 may include a hard disk, including hard disks arranged in an Redundant Array of Independent Disks (RAID) array, a tape storage drive comprising a physical or virtual magnetic tape data storage device, an optical storage device, or the like. The data may be arranged in a database and accessible through Structured Query Language (SQL) queries, or other data base query languages or operations.

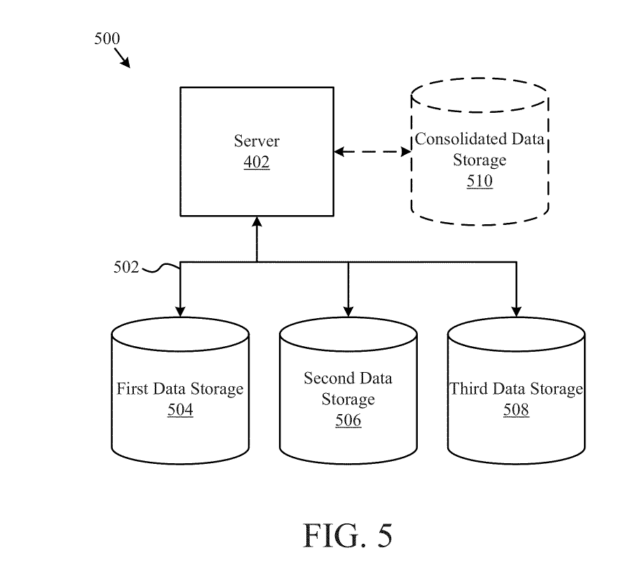

FIG. 5 illustrates one embodiment of a data management system 500 configured to store measured data from a sensor network. In one embodiment, the data management system 500 may include the server 402. The server 402 may be coupled to a data-bus 502. In one embodiment, the data management system 500 may also include a first data storage device 504, a second data storage device 506, and/or a third data storage device 508. In further embodiments, the data management system 500 may include additional data storage devices (not shown). In such an embodiment, each data storage device 504, 506, and 508 may each host a separate database that may, in conjunction with the other databases, contain redundant data. Alternatively, a database may be spread across storage devices 504, 506, and 508 using database partitioning or some other mechanism. Alternatively, the storage devices 504, 506, and 508 may be arranged in a RAID configuration for storing a database or databases through may contain redundant data. Data may be stored in the storage devices 504, 506, 508, 510 in a database management system (DBMS), a relational database management system (RDMS), an Indexed Sequential Access Method (ISAM) database, a Multi Sequential Access Method (MSAM) database, a Conference on Data Systems Languages (CODASYL) database, or other database system.

In one embodiment, the server 402 may submit a query to select data from the storage devices 504 and 506. The server 402 may store consolidated data sets in a consolidated data storage device 510. In such an embodiment, the server 402 may refer back to the consolidated data storage device 510 to obtain a set of records. Alternatively, the server 402 may query each of the data storage devices 504, 506, and 508 independently or in a distributed query to obtain the set of data elements. In another alternative embodiment, multiple databases may be stored on a single consolidated data storage device 510.

In various embodiments, the server 402 may communicate with the data storage devices 504, 506, and 508 over the data-bus 502. The data-bus 502 may comprise a Storage Area Network (SAN), a Local Area Network (LAN), or the like. The communication infrastructure may include Ethernet, Fibre-Chanel Arbitrated Loop (FC-AL), Fibre-Channel over Ethernet (FCoE), Small Computer System Interface (SCSI), Internet Small Computer System Interface (iSCSI), Serial Advanced Technology Attachment (SATA), Advanced Technology Attachment (ATA), Cloud Attached Storage, and/or other similar data communication schemes associated with data storage and communication. For example, the server 402 may communicate indirectly with the data storage devices 504, 506, 508, and 510 by first communicating with a storage server (not shown) or the storage controller 404.

The server 402 may include modules for interfacing with the data storage devices 504, 506, 508, and 510, interfacing a network 408, interfacing with a user through the user interface device 410, and the like. In a further embodiment, the server 402 may host an engine, application plug-in, or application programming interface (API).

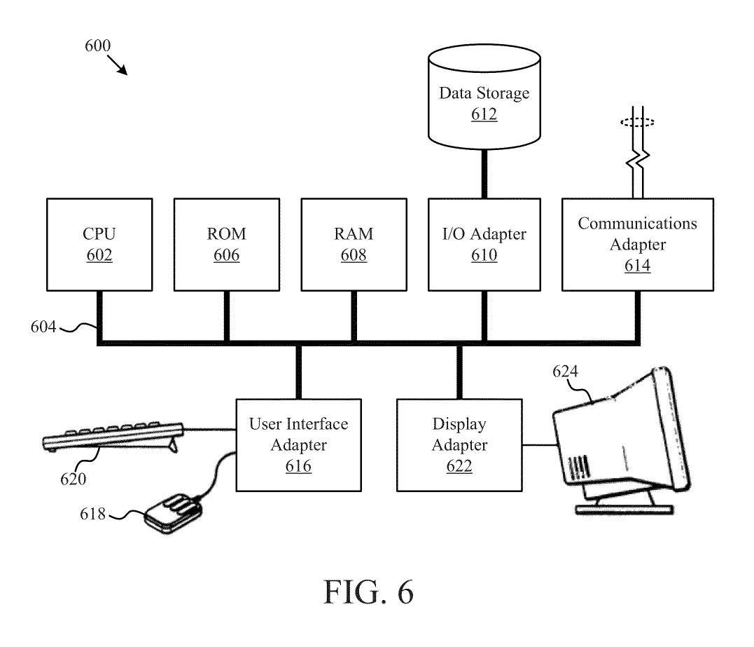

FIG. 6 illustrates a computer system 600 adapted according to certain embodiments of the server 402 and/or the user interface device 410. The central processing unit (“CPU”) 602 is coupled to the system bus 604. The CPU 602 may be a general purpose CPU or microprocessor, graphics processing unit (“GPU”), and/or microcontroller. The present embodiments are not restricted by the architecture of the CPU 602 so long as the CPU 602, whether directly or indirectly, supports the modules and operations as described herein. The CPU 602 may execute the various logical instructions according to the present embodiments.

The computer system 600 also may include random access memory (RAM) 608, which may be SRAM, DRAM, SDRAM, or the like. The computer system 600 may utilize RAM 608 to store the various data structures used by a software application such as databases, tables, and/or records. The computer system 600 may also include read only memory (ROM) 606 which may be PROM, EPROM, EEPROM, optical storage, or the like. The ROM may store configuration information for booting the computer system 600. The RAM 608 and the ROM 606 hold user and system data.

The computer system 600 may also include an input/output (I/O) adapter 610, a communications adapter 614, a user interface adapter 616, and a display adapter 622. The I/O adapter 610 and/or the user interface adapter 616 may, in certain embodiments, enable a user to interact with the computer system 600. In a further embodiment, the display adapter 622 may display a graphical user interface associated with a software or web-based application on a display device 624, such as a monitor or touch screen.

The I/O adapter 610 may connect one or more storage devices 612, such as one or more of a hard drive, a compact disk (CD) drive, a floppy disk drive, and a tape drive, to the computer system 600. The communications adapter 614 may be adapted to couple the computer system 600 to the network 408, which may be one or more of a LAN, WAN, and/or the Internet. The communications adapter 614 may be adapted to couple the computer system 600 to a storage device 612. The user interface adapter 616 couples user input devices, such as a keyboard 620, a pointing device 618, and/or a touch screen (not shown) to the computer system 600. The display adapter 622 may be driven by the CPU 602 to control the display on the display device 624.

The applications of the present disclosure are not limited to the architecture of computer system 600. Rather the computer system 600 is provided as an example of one type of computing device that may be adapted to perform the functions of a server 402 and/or the user interface device 410. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
receiving an input string;
parsing the input string to extract at least one noun and at least one verb;
retrieving at least one image from a database for each noun;
associating each of the verbs with at least one of the nouns; and
creating a timeline animating the images corresponding to the nouns according to the verbs associated with the nouns.

2. The method of claim 1, in which the step of receiving the input string comprises receiving a request to animate the input string through a web service.

3. The method of claim 1, in which the step of parsing the input string comprises parsing the input string with a natural language processor engine.

4. The method of claim 1, further comprising rendering an animation according to the timeline.

5. The method of claim 4, further comprising transmitting the rendered animation to a client device.

6. The method of claim 1, in which the step of creating the timeline comprises assigning a motion path to each of the nouns based, in part, on the associated verb.

7. The method of claim 1, further comprising:
parsing the input string to extract at least one adjective;
associating each of the adjectives with at least one of the nouns; and
adjusting the image corresponding to the noun in accordance with the adjective associated with the noun.

8. A computer program product, comprising:
a non-transitory computer readable medium comprising:
code to receive an input string;
code to parse the input string to extract at least one noun and at least one verb;
code to retrieve at least one image from a database for each noun;
code to associate each of the verbs with at least one of the nouns; and
code to create a timeline animating the images corresponding to the nouns according to the verbs associated with the nouns.

9. The computer program product of claim 8, in which the code to receive the input string comprises code to receive a request to animate the input string through a web service.

10. The computer program product of claim 8, in which the code to parse the input string comprises code to parse the input string with a natural language processor engine.

11. The computer program product of claim 8, in which the medium further comprises code to render an animation according to the timeline.

12. The computer program product of claim 11, in which the medium further comprises code to transmit the rendered animation to a client device.

13. The computer program product of claim 8, in which the code to create the timeline comprises code to assign a motion path to each of the nouns based, in part, on the associated verb.

14. The computer program product of claim 8, in which the medium further comprises:
code to parse the input string to extract at least one adjective;
code to associate each of the adjectives with at least one of the nouns; and
code to adjust the image corresponding to the noun in accordance with the adjective associated with the noun.

15. A system, comprising:
a natural language processor coupled to a web service to receive an input string and output nouns and verbs;
a reference database coupled to the natural language processor to receive nouns and verbs and output images corresponding to the nouns and instructions corresponding to the verbs;
a processor coupled to the reference database, in which the processor is configured:
to associate verbs with nouns; and
to create a timeline animating an image associated with each noun according to instructions corresponding to the associated verb.

16. The system of claim 15, in which the processor is further configured to render an animation according to the timeline.

17. The system of claim 16, in which the processor is further configured to transmit the rendered animation to a client device through the web service.

18. The system of claim 17, in which the processor is further configured to transmit the rendered animation as at least one of hypertext markup language 5 (HTML5) file, an animated vector graphics file, and a video file.

19. The system of claim 15, in which the natural language processor outputs adjectives from the input string, and in which the reference database receives the adjectives from the natural language processor and outputs instructions corresponding to the adjectives, and in which the processor is further configured:
to associate adjectives with nouns; and
to adjust the image corresponding to a noun in accordance with the instructions corresponding to the adjective.

20. The system of claim 15, in which the reference database is at least one of a structured query language (SQL) server, a database management system (DBMS), a relational database management system (RDMS), an indexed sequential access method (ISAM) database, a multi-sequential access method (MSAM) database, a conference on data systems languages (CODASYL) database
